(19) United States
(12) Patent Application Publication
(10) Pub. No.: US 2005/0132910 A1
(43) Pub. Date: Jun. 23, 2005

(54) Gravure printing cylinder

(75) Inventors: Wilfried Kolbe, Gulzow (DE); Klaus Schirrich, Bielefeld (DE); Bodo Steinmeier, Bielefeld (DE); Andreas Kuckelmann, Ibbenburen (DE)

Correspondence Address: RICHARD M. GOLDBERG, 25 EAST SALEM SREEET, SUITE 419, HACKENSACK, NJ, 07601, US

(73) Assignee: Fischer & Krecke GmbH & Co., Bielefeld (DE)

(21) Appl. No.: 10/999,674

(22) Filed: Nov. 30, 2004

(30) Foreign Application Priority Data
Dec. 19, 2003 (EP) 03 029 386.4

(51) Int. Cl. B41N 1/04

(52) U.S. Cl. 101/153; 101/375

(57) ABSTRACT

Gravure printing cylinder with a block carrier (12) having a metallic gravure layer (24) applied to its peripheral surface, with the block carrier being a self-supporting sleeve (12) made of carbon fiber composite material and supported on disks (14).

The invention relates to a gravure printing cylinder comprising a block carrier having a peripheral surface to which a metallic gravure layer is applied.

The block carrier of a gravure printing cylinder has heretofore, in view of the high mechanical loads, been formed by a steel cylinder having an axle firmly welded thereto or thereinto. A nickel layer having a thickness of 2 μm for example, is applied to the peripheral surface of the steel cylinder, and this nickel layer carries in turn one or more copper layers serving as the gravure layer, for example, a layer of priming copper, on which a separating layer with a thickness of 1 μm and then another copper layer having a thickness of about 60 to 120 μm is applied, the so-called form copper or Ballad skin. The ink-receiving pits of the gravure printing cylinder are engraved electromechanically, chemically or by means of a laser into the form copper and, after gravure, the cylinder is chrome-plated.

Since the steel gravure printing cylinder has a considerable weight, in particular in case of large printing length and width, suitable equipment such as cranes, manipulators, robots and the like are used for handling the gravure printing cylinder, when the cylinder is to be exchanged, for example.

It is an object of the invention to provide a gravure printing cylinder which can be handled more easily.

To achieve this object, according to the invention, the block carrier is formed by a self-supporting sleeve made of carbon fiber composite material and supported on disks.

By replacing the conventional steel cylinder with a cylinder that consists essentially of carbon fiber composite material and has a substantially lower weight, the handling is greatly facilitated, so that a cylinder change may easily be carried out by the operating personal by hand, even in case of large printing widths of, for example, 1 to 2 m or more and also in case of large cylinder diameters of 10 to 20 cm, for example. Thus, expensive equipment can be dispensed with and, moreover, the cylinder change operation can be accelerated.

EP-A-1 025 996 discloses already a printing plate cylinder for a flexographic printing machine, wherein the cylinder has a sleeve made of carbon fiber composite material with a wound structure of carbon fibers, the cylinder being supported on two disks. The printing plates are then fixed on this cylinder either directly or with use of a sleeve thrust thereupon. Although, in case of a gravure printing cylinder, the gravure layer is formed directly on the surface of the block carrier and the line pressure in the print process is approximately 10 times higher than in case of a flexographic printing machine, it has turned out, surprisingly, that the mechanical requirements can be met by a sleeve of carbon fiber composite material even for a gravure printing cylinder.

Advantageous embodiments of the invention are indicated in the dependent claims.

The disks carrying the sleeve may also be made of carbon fiber-reinforced plastics or, alternatively, of steel or aluminum. They may either be flush with the ends of the sleeve or may be somewhat offset inwardly for better controlling the distortions occurring in the print process. Optionally, the two disks are additionally connected by an internal tube made of carbon fiber reinforced plastics, glass fiber-reinforced plastics, steel or aluminum. This stabilizes the gravure printing cylinder as a whole and, in addition, provides a good guidance when, in the event of a cylinder change, the gravure printing cylinder is thrust onto a supporting or clamping axle of a printing machine.

In the gravure printing cylinder according to the invention, the layers of nickel, copper, etc. are formed on the carbon fiber composite material either directly or by means of a primer layer, e.g. galvanically or by powder or plasma spray coating.

In addition to a considerable weight reduction and a shortening of the set-up times for the gravure printing machine achieved thereby, the invention has the further advantage that a gravure printing cylinder made of carbon fiber composite material has a spectrum of Eigenfrequencies which is clearly different from that of a steel cylinder and has a greater distance from the excitation frequencies occurring in a printing machine, so that smoother running properties and, due to the high rigidity and the good damping properties of the carbon fiber composite material, an improved print quality can also be achieved.

An embodiment example will now be described in conjunction with the drawings, wherein:

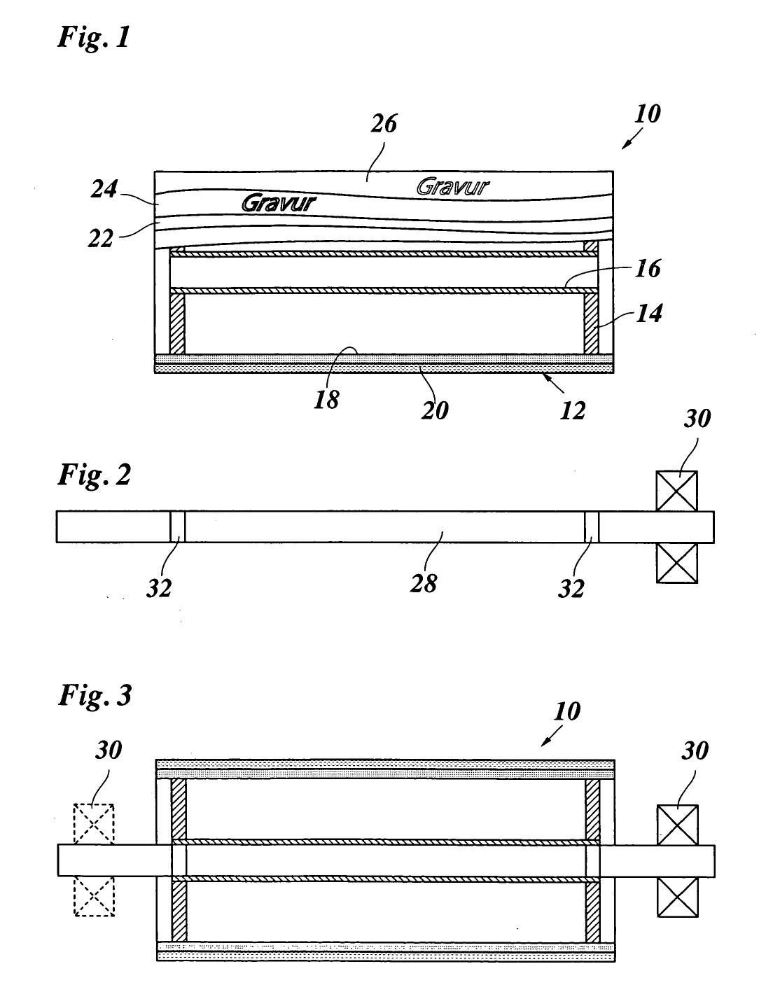

FIG. 1 is a partially broken-away view of a gravure printing cylinder according to the invention:

FIG. 2 is a schematic view of a support axle of a printing machine onto which the gravure printing cylinder shown in FIG. 1 is to be thrust; and

FIG. 3 is a sectional view of the gravure printing cylinder that has been thrust onto the support axle.

The gravure printing cylinder 10 shown in FIG. 1 has a self-supporting sleeve 12 made of carbon fiber composite material, e.g. carbon fiber-reinforced synthetic resin, which is supported on radial disks 14 in the vicinity of both ends of the cylinder. The annular disks 14, which themselves may be made carbon fiber-reinforced synthetic resin, are connected to one another in the region of their internal peripheries by a guide tube 16 made of steel, aluminum or fiber-reinforced synthetic resin. The guide tube 16 and the sleeve 12 are separated by a considerable radial spacing which may vary depending on the desired printing length of the gravure printing cylinder 10. For example, the printing length may vary between 400 and 1100 mm, and the printing width (length of the sleeve 12) may be in a range from 800 to 1600 mm.

In the example shown, the sleeve 12 has two layers 18, 20 of carbon fiber-reinforced material, e.g. an inner layer 18 in which the carbon fibers extend or are wound essentially in circumferential direction or diagonally, and an outer layer 20 in which the carbon fibers are predominantly oriented in axial direction. However, other configurations of the carbon fiber structure as well as single-layer constructions of the sleeve 12 are also conceivable. The overall wall thickness of the sleeve 12 should be more than 4 mm and is in the order or magnitude of 6 to 20 mm, depending on the size of the printing cylinder, so that, in spite of the high line pressure occurring in the gravure printing process, the gravure printing cylinder 10 as a whole has a high distortion resistance and a good dampening behavior.

A layer 22 of nickel or another suitable material with a thickness of a few μm is formed on the outer peripheral surface of the sleeve 12, e.g. galvanically or by spray coating, and, as is conventional for gravure printing cylinders, this layer carries in turn a gravure layer 24 which may for example consist of several layers of different copper alloys. The ink-receiving, printing recesses of the gravure printing cylinder are engraved in the gravure layer 24, as has been symbolized in FIG. 1 by the writing “Gravur”. Subsequent to the gravure process, a chrome layer 26 is applied in the usual way.

The gravure printing cylinder 10 described above, in spite of its high mechanical strength, has a low weight, which leads to an improved resonance behavior and drastically reduced forces of inertia during the printing operation, and, in the instant of a cylinder change, has the advantage that even gravure printing cylinders for very large printing lengths and printing widths may be handled manually without using a robot or similar equipment.

FIG. 2 schematically shows a support axle 28 which serves for supporting the gravure printing cylinder 10 and is supported in a frame of a printing machine, which has not been shown, by means of bearings 30 so as to be driven for rotation. In two positions corresponding to the positions of the disks 14 in FIG. 1, the supporting axle 28 has mechanical or hydraulic clamping devices 32 for the gravure printing cylinder 10. When the cylinder is to be exchanged, the bearing at one end of the support axle 28 is removed, so that the support axle is held in the printing machine in cantilever fashion, as has been shown in FIG. 2. Then, the printing cylinder 10 may easily be pushed by hand onto the support axle with its guide tube 16 and is then fixed by means of the clamping devices 32, as has been shown in FIG. 3. After closing and locking the bearing 30 on the left side in FIG. 3, the printing machine is again ready for printing after a very short set-up time.

1. Gravure printing cylinder comprising a block carrier having a metallic gravure layer applied to a peripheral surface thereof, the block carrier being a self-supporting sleeve made of a carbon fiber composite material and supported on disks.

2. Gravure printing cylinder according to claim 1, wherein the sleeve has at least one layer in which the carbon fibers extend essentially in a circumferential direction.

3. Gravure printing cylinder according to claim 1, wherein the sleeve has at least one layer in which the carbon fibers extend essentially in an axial direction.

4. Gravure printing cylinder according to claim 1, wherein the disks are inwardly offset relative to the ends of the gravure printing cylinder.

5. Gravure printing cylinder according to claim 1, wherein the disks are interconnected by a guide tube which is surrounded by the sleeve with a radial spacing.

6. Gravure printing cylinder according to claim 1, wherein the disks are adapted to be fixed on a support axle of a gravure printing machine with mechanical or hydraulic clamping devices.

7. Gravure printing cylinder according to claim 1, wherein at least one of the gravure layer and a metallic intermediate layer is galvanically applied to the carbon fiber containing material of the sleeve.

8. Gravure printing cylinder according to claim 1, wherein at least one of the gravure layer and a metallic intermediate layer is applied to the peripheral surface of the sleeve by spray coating.
